(19) United States
(12) Patent Application Publication
(10) Pub. No.: US 2006/0099008 A1
(43) Pub. Date: May 11, 2006

(54) Image forming apparatus

(75) Inventor: Shigeharu Kurita, Abiko-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/262,766

(22) Filed: Nov. 1, 2005

(30) Foreign Application Priority Data
Nov. 11, 2004 (JP) 2004-327564

(51) Int. Cl. G03G 15/00; G03G 21/00

(52) U.S. Cl. 399/110; 399/124

(57) ABSTRACT

There is provided an image forming apparatus that forms an image using an intermediate transfer member, and that improve the accuracy of position of the intermediate transfer member with respect to an apparatus main body. The image forming apparatus transfers the image formed on a photosensitive drum onto an intermediate transfer belt 2, transfers the image on the intermediate transfer belt 2 onto a sheet, and then fixes the image on the sheet using a fixing unit 5. The image forming apparatus has a discharge unit 51 which is capable of opening and closing with respect to the apparatus main body. An intermediate transfer unit 2A having the intermediate transfer belt 2 is swingably supported on the discharge unit 51, and positioned by the apparatus main body when the discharge unit 51 is closed.

### BACKGROUND OF THE INVENTION

1. Field of the Invention

The present invention relates to an image forming apparatus such as a copying machine, a printer, a recording apparatus, and the like, more specifically relates to a construction of positioning an intermediate transfer belt.

2. Related Background Art

An image forming apparatus for recording an image while conveying a sheet may be so constructed that a part of the apparatus can be swingably opened and closed, for the purpose of removing a jammed sheet or exchanging an internal unit. On this occasion, a part of the apparatus constructing the image forming apparatus, such as a sheet conveying unit, a fixing unit and the like may be disposed on a swing section serving also as an outer package.

For example, the image forming apparatus comprises an intermediate transfer belt as a belt member, a first swing section for supporting a fixing unit, a secondary transfer roller as a sheet conveying unit and the like and forming a part of an output tray, and a second swing section for supporting an intermediate transfer belt, in which the first swing section and the second swing section are so constructed as to swing around different fulcrum shafts, respectively.

In a swing construction shown in Japanese Patent Application Laid-Open No. 2003-156984 (FIG. 6, FIG. 8, and FIG. 10), since the intermediate transfer belt is directly fixed to the second swing section, therefore, the intermediate transfer belt is positioned through at least two parts of a chassis which bears the fulcrum shaft of the second swing section, and the second swing section.

Further, similarly, the secondary transfer roller also is positioned through at least two parts of a chassis which bears the fulcrum shaft of the first swing section for supporting the secondary transfer roller, and the first swing section.

That is, stabilization of the output image requires that the intermediate transfer belt and the secondary transfer roller abut to each other with a high accuracy of position. However, according to the above-mentioned construction, the accuracy of position of the secondary transfer roller with respect to the intermediate transfer belt depends on the accuracies of the respective parts and the attaching accuracies of all the chassis (the rotating fulcrum shaft of the second rotating section), the chassis (the rotating fulcrum shaft of the first rotating section), and the first rotating shaft.

On this occasion, a problem has been caused of the accuracy of position of the intermediate transfer belt lowering with respect to an apparatus main body, when the intermediate transfer belt and the secondary transfer roller are abutted to each other.

### SUMMARY OF THE INVENTION

The invention has been achieved in view of the above-mentioned points. It is, therefore, an object of the invention to provide an image forming apparatus for forming an image using an intermediate transfer member, and that is capable of improving the accuracy of position of the intermediate transfer member with respect to an apparatus main body.

Further, it is another object of the invention to provides an image forming apparatus comprising an image bearing member that bears a visible image; an intermediate transfer member onto which the visible image on the image bearing member is transferred; a transfer unit which transfers the visible image on the intermediate transfer member onto a recording material; an intermediate transfer unit which includes the intermediate transfer member; and an opening and closing member what is capable of opening and closing with respect to an apparatus main body, wherein the intermediate transfer unit is swingably supported by the opening and closing member, and then positioned by the apparatus main body when the opening and closing member is closed.

### BRIEF DESCRIPTION OF THE DRAWINGS

FIG. 1 is a view showing an overall structure of an image forming apparatus;

FIG. 2 is a sectional view of the image forming apparatus, showing a case in which a fixing frame is opened;

FIG. 3 is a sectional view of the image forming apparatus, showing a case in which a fixing frame and a discharge unit are opened;

FIG. 4 is a view which is useful in explaining an operation of the discharge unit, showing a case in which the discharge unit is going to be closed with respect to the apparatus main body;

FIG. 5 is a view which is useful in explaining an operation of the discharge unit, showing a case in which the discharge unit is going to be closed with respect to the apparatus main body;

FIG. 6 is a view which is useful in explaining an operation of the discharge unit, showing a case in which the discharge unit is going to be closed with respect to the apparatus main body;

FIG. 7 is a view which is useful in explaining an operation of the discharge unit, showing a case in which the discharge unit is going to be closed with respect to the apparatus main body;

FIG. 8 is a view which is useful in explaining an operation of the discharge unit, showing a case in which the discharge unit is closed with respect to the apparatus main body.

### DETAILED DESCRIPTION OF THE EMBODIMENTS

According to the invention, the intermediate transfer unit is swingably supported by the opening and closing member, and positioned by the apparatus main body when the opening and closing member is closed; therefore, it is possible of improve the accuracy of position of the intermediate transfer member with respect to the apparatus main body to thereby stabilize the output image.

The invention will be described in detail hereinafter.

The image forming apparatus according to an embodiment will be described with reference to the drawings.

[Overall Structure of the Image Forming Apparatus]

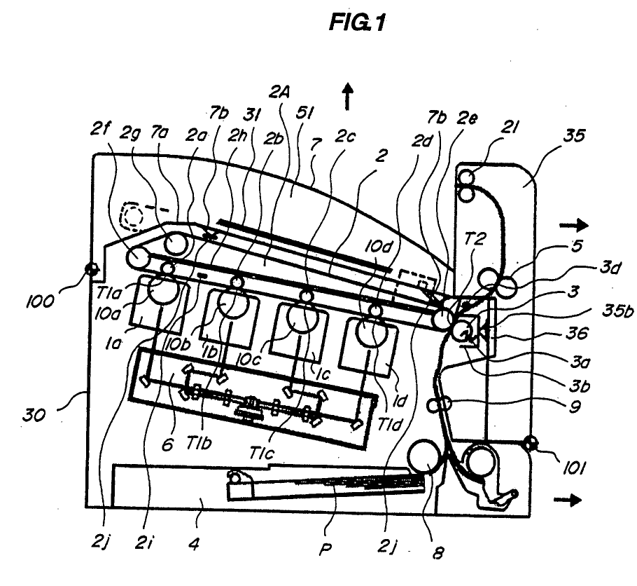

An overall structure of an image forming apparatus will be described hereinbelow with reference to FIG. 1. FIG. 1 is a view of showing an arrangement of an image forming apparatus according to the present embodiment.

An image forming apparatus shown in FIG. 1 has four photosensitive drums 10a, 10b, 10c, 10d, as image bearing members, for bearing toner images (visible images) of yellow, magenta, cyan, and black. Around each of the photosensitive drums 10a to 10d are arranged a charger, a development unit, and a cleaner (all not shown), which are unitized as a process cartridge 1a, 1b, 1c, and 1d. An intermediate transfer belt 2, as an example of a belt member which is an intermediate transfer member, is disposed above the process cartridges 1a to 1d so as to contact the respective photosensitive drums 10a to 10d.

The chargers (not shown) charge photosensitive drums 10a to 10d, respectively. An exposing unit 6 exposes optical images of yellow, magenta, cyan, and black colors to form yellow, magenta, cyan, and black latent images. The development unit develops the respective latent images to thereby form yellow, magenta, cyan, and black toner images on the photosensitive drums 10a to 10d.

Rotation of the photosensitive drums 10a to 10d causes the toner images to reach primary transfer sections at which the photosensitive drums 10a to 10d abut to the intermediate belt 2. These toner images are sequentially transferred to the intermediate transfer belt 2 by the primary transfer rollers (primary transfer units) 2a to 2d which are disposed so as to be opposed to the respective photosensitive drums 10a to 10d. The toner images are transferred from the photosensitive drums 10a to 10d at the primary transfer sections T1a to T1d. To the primary transfer rollers 2a, 2b, 2c, 2d are applied primary transfer biases from an electrical equipment board.

Sheets (recording materials) P contained in a sheet cassette 4 are fed one by one by a pick-up roller 8. And then timed by a registration roller 9. Thereafter, the sheet P is conveyed up to a nip section (a secondary transfer section) T2 which is constructed by a secondary transfer roller (a transfer unit, a secondary transfer unit) 3 and the intermediate transfer belt 2, followed by the toner image on the intermediate transfer belt 2 being secondarily transferred in block to the sheet P.

Then, the sheet P having the transferred toner image is conveyed to a fixing unit 5, and hence subjected to heat and pressure by the fixing unit 5, thereby causing the not-yet-toner image to be fixed to the sheet P, which causes the respective color toners to be molten and mixed in color to provide a full color print image fixed to the sheet P. Thereafter, the sheet P is discharged to an output tray 7, as a sheet discharging section, by a discharge and convey unit disposed at a location downstream of the fixing unit 5.

Thus constructed image forming apparatus according to the embodiment has the sheet cassette 4, the exposing unit 6, and the process cartridges 1a to 1d, the intermediate transfer belt and the output tray 17, in the order named from a lower portion of an apparatus main body 30 to an upper portion. In the apparatus main body 30 is disposed a main electric equipment board for controlling the whole image forming apparatus including a fixed power supply. Further, an electrical equipment board 31 is disposed above the intermediate transfer belt 2 and below the output tray 7, for applying a transfer bias to the primary transfer roller 2a to 2d and the secondary transfer roller 3. On this occasion, the output tray 7 forms curvature surface and inclined from the downstream side to the upstream side with respect to a discharging direction of the discharge and convey unit 21, and then the electric equipment board 31 is disposed in a space formed between the output tray 7 and the intermediate transfer belt 2.

Besides, as to FIG. 1 showing the image forming apparatus according to this embodiment, the right-hand side shows a front operation side of the apparatus, and the left-hand side shows a rear side of the apparatus.

[Positioning of Intermediate Transfer Unit]

Then, a description will be given of a construction of positioning an intermediate transfer unit 2A having the intermediate transfer belt 2 in such a condition as that the intermediate transfer unit 2A is set to the main body.

The intermediate transfer belt 2 is tightly stretched due to tension rollers 2e, 2f, and 2g, and then there is provided a transfer frame 2h for supporting the tension rollers 2e to 2g and the primary tension rollers 2a to 2d, and the like. Moreover, the intermediate transfer belt 2, the primary transfer rollers 2a to 2d, the tension rollers 2e, 2f, and 2g, and the transfer frame 2h are unitized as an intermediate transfer unit 2A.

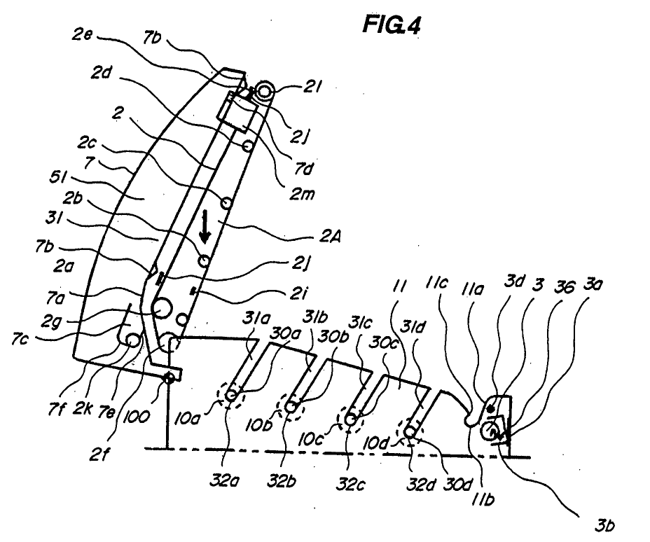

The intermediate transfer unit 2A is, as will be described later, swingably supported on the discharge unit 51 having the output tray 7, but restricted, relative to a main body side plates 11 (refer to FIG. 4) disposed in the apparatus main body 30, by a fitting section 11b (refer to FIG. 4) of the main body side plates 11 in the height direction and the forward-backward direction on a side of the tension roller 2e. Whereas, seats 2i disposed on the transfer frame 2h is restricted by abutting to flat surfaces (not shown) of the main body side plates 11 in the height direction on a side of the tension roller 2f.

Further, the transfer frame 2h has seats 2j on a side of the tension roller 2e and on a side of the tension roller 2f, respectively, and the output tray 7 has elastic members such as dogleg line springs 7b protruding from the output tray 7, or plate springs, or the like at locations opposed to the seats 2j.

According to the construction described above, on a side of one of the main body side plates 11 (described later), the line springs 7b of the output tray 7 abutting to the seats 2j of the transfer frame 2h enables the intermediate transfer unit 2A to be positioned in the height direction and the forward-backward direction by the fitting section 11b of the main body side plates 11b on a side of the tension roller 2e as the front operation side of the apparatus, and the seats 2i of the transfer frame 2h abutting to the flat surfaces (not shown) of the main body side plates 11 enables the intermediate transfer unit 2A to be positioned in the height direction on a side of the tension roller 2f as the rear operation side of the apparatus. Moreover, the main body side plates 11 are identical in shape with each other and disposed in the apparatus main body so as to be opposed to each other both left and right sides viewed from the front operation side of the apparatus.

On this occasion, the discharge unit 51 swingably supporting the intermediated transfer unit 2A and the fixing frame 35 having the fixing unit 5 are constructed to be swingably opened or closed with respect to the apparatus main body 30. That is, opening the discharge unit 51, as a first opening or closing member, allows the process cartridges 1a to 1d to be exposed, with easy exchange of the cartridges. Further opening the fixing frame 35, as a second opening and closing member, allows a sheet conveying path to be exposed, with easy removal of a jammed sheet.

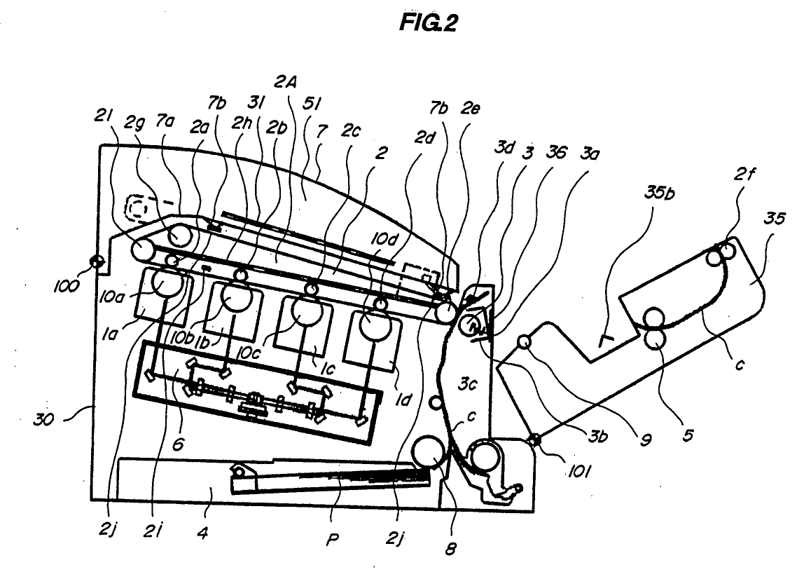

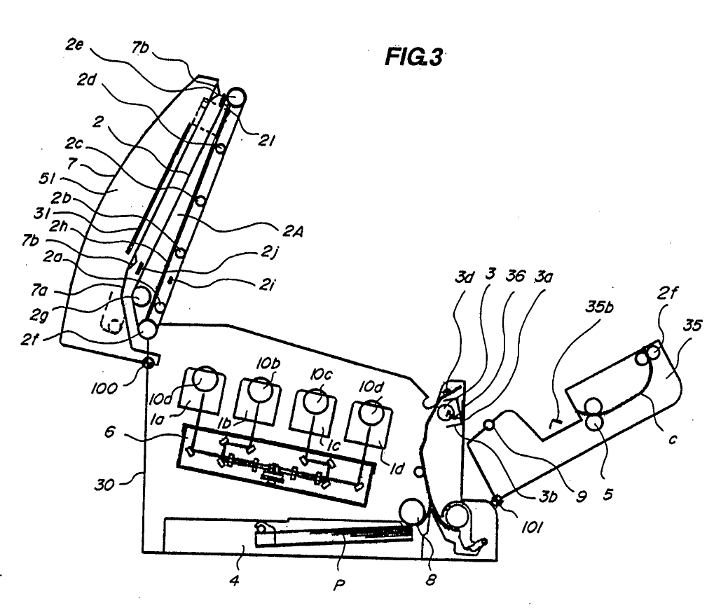

Next, a description will be given of a construction of opening and closing the fixing frame 35 and the discharge unit 51 as the above-mentioned opening and closing members. FIG. 2 is a sectional view of the image forming apparatus, showing a case in which the fixing frame 35 is opened, and FIG. 3 is a sectional view of the image forming apparatus, showing a case in which the discharge unit 51 are opened.

[Construction of Opening or Closing Fixing Frame]

As shown in FIG. 2, the fixing frame 35 is swingable in the embodiment. This fixing frame 35 is provided with the fixing unit 5 and a part of a sheet path C as an example of the sheet conveying path, and then is so constructed as to be swingable toward one side of the apparatus (on the front operation side of the apparatus in the embodiment) around the fulcrum shaft 101 disposed on the apparatus main body 30 on one side thereof.

Therefore, the apparatus is so constructed that opening the fixing frame 35 provides a jam clearance operation, when the sheet P fed by the pick-up roller 8 from the cassette 4 has been jammed while transferring and hence stacked within the sheet path C, or when the sheet P has been jammed in the fixing unit 5.

The secondary transfer roller 3, as a secondary transfer unit, is swingably supported on a holder 3b disposed on the apparatus main body 30, and urged toward the intermediate transfer belt 2 by compression springs 3a. The secondary transfer roller 3, the compression springs 3a, and the holder 3b construct a secondary transfer unit 3c.

Further, the secondary transfer roller 3c is swingably mounted onto the apparatus main body 30 as centered around a fulcrum shaft 3d. Then, the fulcrum shaft 3d is located at such a position as that the secondary transfer roller 3 is separated from the intermediate transfer belt 2, as shown in FIG. 2, when the secondary transfer roller unit 3c swings by its own weight during opening of the fixing frame 35.

Besides, a reinforcing member 36 connecting the main body side plate (reference numeral 11 in FIG. 4) and the side plate opposed thereto (not shown) to thereby construct a part of a main body frame is disposed between the secondary transfer roller unit 3c and the fixing frame 35. This reinforcing member 36 has an opening portion (not shown) at both end thereof with respect to its longitudinal direction (a direction perpendicular to a sheet of FIG. 2).

On the other hand, the fixing frame 35 has the dogleg line springs 35b, as examples of separating and contacting units, fixed thereto at locations opposite to the opening portions (not shown) of the reinforcing member 36. When the fixing frame 35 is closed, the line springs 35b urge the holder 3b through the opening portion (not shown) to swing the secondary transfer roller unit 3c around the fulcrum shaft 3d. The secondary transfer roller unit 3c abuts to a restriction section (not shown) disposed in the apparatus main body at a predetermined position, to thereby be positioned. That is, opening or closing the fixing frame 35 allows the secondary transfer roller 3 to separate from or contact the intermediate transfer belt 2.

According to the above-mentioned construction, as shown in FIG. 2, when opening the fixing frame 35, the secondary transfer roller 3 is separated from the intermediate transfer belt 2, thereby causing the sheet path C to be opened, which allows the jam clearance operation when the sheet P has been jammed before or after the nip section between the secondary transfer roller 3 and the intermediate transfer belt 2.

Further, when the sheet P has been jammed and hence stayed in the fixing unit 5, opening the fixing frame 35 causes the secondary transfer roller 3 to separate from the intermediate belt 2, thereby allowing the sheet path C to be opened. Accordingly, the sheet P which is engaged in the fixing unit 5 can be pulled out. Therefore, operating the pressure releasing lever (not shown) in the fixing unit 5 to release the nip of the roller pair formed in the fixing unit 5 enables the sheet P stayed in the fixing unit 5, thereby facilitating the jam clearance operation.

[Construction of Opening or Closing Discharging Unit]

Besides, as shown in FIG. 3, the discharge unit 51 is swingable. That is, the discharge unit 51 swingably supported in the apparatus main body around the fulcrum shaft 101 disposed in the apparatus main body on an opposite side (a rear side of the apparatus in this embodiment) to the fulcrum shaft 101 of the fixing frame 35. This discharge unit 51 is integral with the discharge frame 7a as one body, and then has the output tray 7 formed on an upper surface thereof Further, the intermediate transfer belt 2 is engaged with the discharge unit 51 by engaging section (not shown).

Therefore, opening the discharge unit 51 around the fulcrum shaft 100 disposed on the apparatus main body 30 causes the intermediate transfer belt 2 to be exposed in conjunction with the discharge unit 51; therefore, when exchanging the process cartridges 1a to 1d as consumable goods, only opening operation of the discharge unit 51 leads to accessing to the process cartridges la to 1d.

[Positioning Construction]

Next, a description will be given of a construction of positioning the intermediate transfer unit 2A. FIGS. 4 to 8 are views which are useful in explaining operations of the main part from a state in which the discharge unit 5 is opened to a state in which the discharge unit 5 is set to a predetermined position.

In FIGS. 4 to 8, a guide section 11a for guiding the intermediate transfer unit 2A when the discharge unit 51 is opened or closed and fitting section 11b for use in positioning is disposed on the main body side plates 11 provided on the apparatus main body in the vicinity of the secondary transfer roller 3. Further, there is provided engaging section 11c with which the secondary transfer unit 2A is engaged in such a manner that, when the discharge unit 51 and the fixing frame 35 are closed, a pressure force due to the secondary transfer roller 3 inhibits the intermediate transfer unit 2A from separating from the fitting section 11b.

Moreover, the process cartridges la to Id have ball bearings 30a, 30b, 30c, and 30d at both ends of the photosensitive drums 10a to 10d, respectively. Outer races of the ball bearings are pulled into fitting sections 32a, 32b, 32c, and 32d while being guided by drum guide sections 31a, 32b, 32c, and 32d of the main body side plates 11, and then locked by locking members (not shown). That is, the process cartridges 1a to 1d are so constructed as to be positioned directly onto the main body side plates 11, respectively.

The intermediate transfer unit 2A is swingably mounted onto the discharge unit 51. As shown in FIG. 4, in a state in which the discharge unit 51 is opened swingably around the fulcrum shaft 100, a boss 2k disposed on the intermediate transfer unit 2A are guided along and then incorporated into U-shaped guides 7c of the discharge unit 51. Further, on a front operation side of the discharge unit 51 (an opposite side to the fulcrum shaft 100), locking members 2m of the intermediate transfer unit 2A are engaged with a nail section 7d of the discharge unit 51 at inner portions thereof, thereby preventing the intermediate transfer unit 2A from dropping out of the discharge unit 51, and enabling the locking members 2m to be easily disengaged, which improves the exchange-workability of the intermediate transfer unit 2A.

On this occasion, as shown in FIG. 4, since the intermediate transfer unit 2A is not fixed when the discharge unit 51 is opened, the intermediate transfer unit 2A is apt to drop due to its own weight in such a direction as to close the discharge unit 51; however, the intermediate transfer unit 2A is maintained in position because the boss 2k abut to inner wall surfaces 7e, 7f of the U-shaped guides 7c and the locking members 2m are separated from the output tray 7 within such a range as that it is capable of engaging with the nail section 7d.

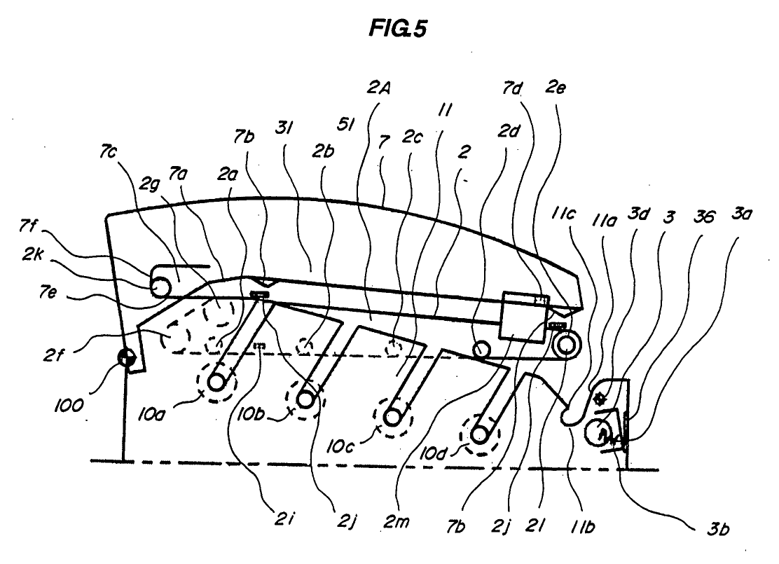

FIG. 5 shows a state in which the intermediate transfer unit 2A is closed swingably around the fulcrum shaft 100 until its primary transfer plane is located in a horizontal position from a state in which the discharging unit 51 is opened shown in FIG. 4. The intermediate transfer unit 2A swings while the bosses 2k abutting to the wall surfaces 7e, 7f of the guides 7c from the opening state to the horizontal state.

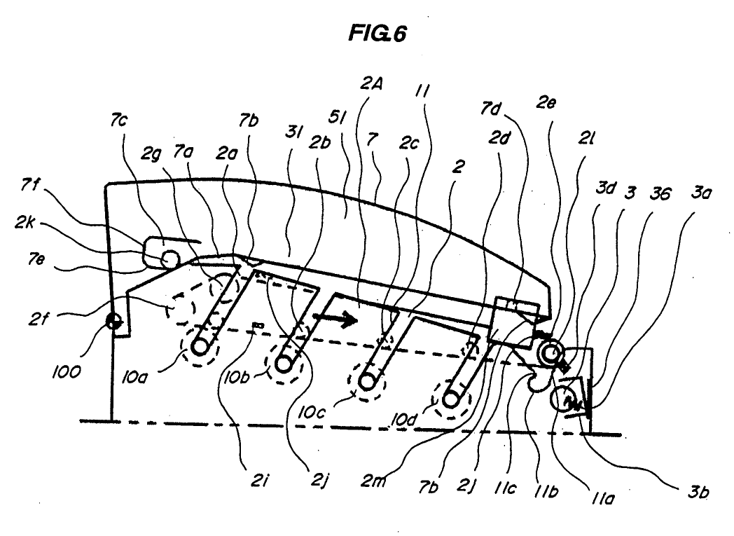

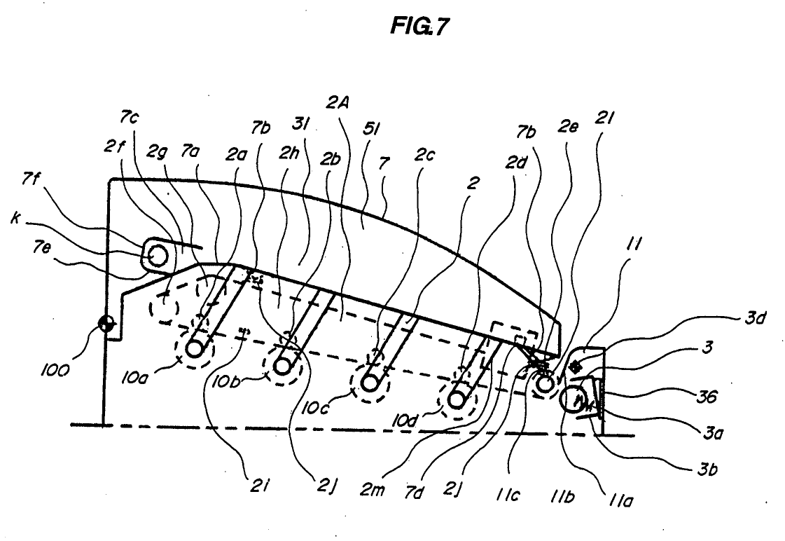

On this occasion, the intermediate transfer unit 2A is adapted to be declined toward the secondary transfer roller 3, when the discharge unit 51 is closed, (refer to FIG. 7). To this end, the intermediate transfer unit 2A is, due to its own weight or a swing operation such as a sudden closing operation of the discharge unit 51, deemed to move toward the front operation side of the discharge unit 51 (an opposite side to the fulcrum shaft 100) before the primary transfer plane reaches substantially the horizontal direction position, followed by acting as shown in FIG. 6 and later.

In FIG. 6, reference numeral 21 designates ball bearings, as section-to-be-fitted, disposed in the intermediate unit 2A, for positioning the intermediate transfer unit 2A onto the main body side plates 11. These ball bearings 21 are coaxial with the tension roller 2e, and disposed at both ends of the tension roller 2e. FIG. 6 represents one of ball bearings 21. When closing the discharge unit 51 lower than a state shown in FIG. 5, the intermediate transfer unit 2A moves toward the secondary transfer roller 3 due to its own weight. Moreover, its moving amount is set due to a play between the locking member 2m and the nail section 7d.

On this occasion, FIG. 6 shows that the boss 2k of the intermediate transfer unit 2A abuts to the wall surface 7e of the guide 7c; however, the seat 2i and the flat surface of the main body side plates 11 may be set in position in such a manner that the seat 2i of the transfer frame 2h on a side of the fulcrum shaft 100 abuts to the flat surface (not shown) of the main body side plates 11.

Swinging the discharge unit 51 in a closing direction causes the outer race of the ball bearing 21 to be introduced into the fitting section 11b and the engaging section 11c as shown in FIG. 7, while abutting to the guide section 11a of the main body side plates 11, which realizes the positioning on a side of the secondary transfer roller 3 of the intermediate transfer unit 2A.

As described above, on an opposite side (on a side of the fulcrum shaft 100) to the secondary transfer roller 3, the seat 2i of the transfer frame 2h abuts to the flat surface (not shown) of the main body side plates 11, thereby resulting the positioning in the height direction. Then, the line spring 7b of the discharge unit 51 abuts to the seat 2j, thereby causing the intermediate transfer unit 2A to be fixed.

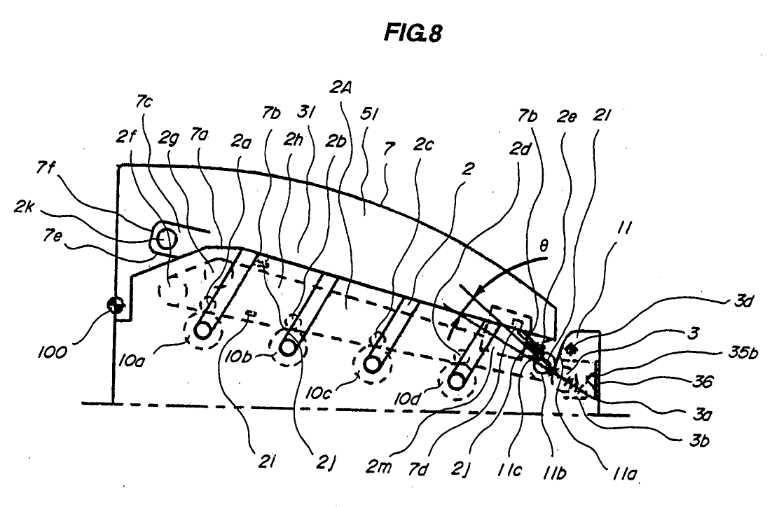

FIG. 8 shows a state in which the discharge unit 51 is closed and then fixed to the apparatus main body, before the fixing frame 35 is closed. Closing the fixing frame 35 causes the line spring 35b to urge the holder 3b as described above, thereby causing the secondary transfer roller unit 3c to swing around the fulcrum shaft 3d. Then, the secondary transfer roller 3 abuts, through the intermediate transfer belt 2, to the tension roller 2e which is coaxial with the ball bearing 21, as a main positioning member of the intermediate transfer unit 2A.

Here, in order that the outer race of the ball bearing 21 of the intermediate transfer unit 2A is reliably fitted to in a state in which the discharge unit 51 and the fixing frame 35 are closed, the engaging section 11c is formed in the main body side plates 11 in such a manner that the outer race of the ball bearing 21 is engaged with the fitting section 11b by an extra amount of θ in FIG. 8 with respect to pressuring direction of the secondary transfer roller 3 to the tension roller 2e. This prevents the ball bearing 21 from being disengaged with the fitting section 11b, thereby ensuring the accuracy of position of the intermediate transfer unit 2A with respect to the main body frame.

Moreover, the above-mentioned embodiment is exemplified by the opening and closing member being adapted to be capable of opening and closing by swinging of the opening and closing member; however, the opening and closing member may be adapted to be capable of opening and closing by sliding of the opening and closing member.

As described above, according to the image forming apparatus of this embodiment, the discharge unit 51 is opened together with the intermediate transfer belt 2 to above the apparatus main body, and then the intermediate transfer belt 2 is swingably engaged with the discharge unit 51 without directly being fixed thereto; therefore, it is possible to remove the intermediate transfer belt 2 from the discharge unit 51 easily, which improves the exchange-workability.

Further, since it is so constructed as to be declined toward the secondary transfer roller 3 when closing the discharge unit 51, the intermediate transfer unit 2A is, during closure of the discharge unit 51, slid with respect to the discharge unit 51 due to its own weight, and guided along and then positioned by the positioning section of the main body. That is, the positioning needs only a construction of forming a guiding shape and a fitting shape of the main body side plates 11 suitably, thereby making this construction simple to prevent the parts count from increasing and further prevent the cost increase.

Moreover, since the fitting section 11b for positioning the intermediate transfer unit 2A by fitting with the ball bearing 21 disposed in the intermediate transfer unit 2A has the engaging section 11c for preventing the intermediate transfer unit 2A from moving against the pressing force of the secondary transfer roller 3, it is capable of positioning, reliably, the tension roller 2e supporting the intermediate transfer belt 2 which is pressed by the secondary transfer roller 3. This resolves a deviation of the alignment between the belt tension roller 2e and the secondary transfer roller 3, thereby eliminating image-relevant influences such as color drift, defective transfer, or the like, and sheet convey-ability-relevant influences such as skew, oblique passing, or the like, which results in stabilization of the output image.

Further, since the intermediate transfer belt 2 and the photosensitive drum are positioned directly on the main body side plates, only ensuring the accuracy of position of the primary transfer roller in the intermediate transfer unit 2A resolves the defective transfer due to the position deviation between the photosensitive drum and the primary transfer roller.

If the exposing unit is fixed to the bottom plates connecting between the main body side plates, the intermediate transfer belt, the photosensitive drum, the exposing unit, and the secondary transfer roller are directly positioned on the main body frame; therefore, it is possible to determine the positional deviation between the respective elements only by the accuracy of the main body frame, thereby resulting in further stabilization of the output image.

Further, the fulcrum shaft 100 of the discharge unit 51 and the fulcrum shaft 101 of the fixing frame 35 are disposed in the apparatus main body, respectively, and one of the rotating fulcrum shaft 101 is disposed on the front operational side of the apparatus main body and the other of the fulcrum shaft 100 is disposed on the rear side of the apparatus main body; therefore, opening the discharge unit 51 and the fixing frame 35 enables the whole apparatus to be opened, and then facilitates a process cartridge exchange and a jam clearance operation.

Further, since the secondary transfer roller 3 is so constructed as to be swingable with respect to the apparatus main body and press the intermediate transfer belt 2 when the fixing frame 35 is closed with the discharge unit 51 closed, the secondary transfer roller 3 presses the positioned intermediate transfer belt 2, thereby enabling both the secondary transfer roller 3 and the intermediate transfer shaft 2 to abut to each other at a high accuracy of position.

Further, since the intermediate transfer unit 2A is swingably engaged with the discharge unit 51 without directly being fixed thereto and then the intermediate transfer belt is positioned by the main body side plates, even if an operator wrongly touches or gives an impact to the output tray, the adding vibration does not directly transmit to the intermediate transfer belt 2, which results in stabilization of the output image.

### CROSS-REFERENCE TO RELATED APPLICATION

This application claims the benefit of priority from the prior Japanese Patent Application No. 2004-327564 filed on Nov. 11, 2004 the entire contents of which are incorporated by reference herein.

What is claimed is:

1. An image forming apparatus comprising:
an image bearing member that bears a visible image;
an intermediate transfer member onto which said visible image on said image bearing member is transferred;
a transfer unit that transfers said visible image on said intermediate transfer member onto a recording material;
an intermediate transfer unit that has said intermediate transfer member; and
an opening and closing member that is capable of opening and closing with respect to an apparatus main body,
wherein said intermediate transfer unit is swingably supported by said opening and closing member, and then positioned by said apparatus main body when said opening and closing member is closed.

2. An image forming apparatus according to claim 1, wherein said opening and closing member has a discharging section that discharges said recording material to above said intermediate transfer member which is swingably supported thereto.

3. An image forming apparatus according to claim 1 or 2, wherein said opening and closing member comprises a first opening and closing member that supports said intermediate transfer unit, and a second opening and closing member that has a fixing unit which fixes said visible image transferred onto said recording material, and that is capable of opening and closing with respect to said apparatus main body.

4. An image forming apparatus according to claim 3, wherein each of said first opening and closing member and said second opening and closing member are swingable around a fulcrum shaft thereof with respect to said apparatus main body, and said fulcrum shaft of said first opening and closing member and said fulcrum shaft of said second opening and closing member are disposed on said apparatus main body, respectively, and one of said fulcrum shafts is disposed on one side of said apparatus main body, and the other of said fulcrum shafts is disposed on the other side of said apparatus main body.

5. An image forming apparatus according to claim 4, wherein said apparatus main body has a fitting section that position said intermediate transfer unit due to fitting with a section-to-be-fitted disposed in said intermediate transfer unit, and said fitting section is disposed on a positioning member of said image bearing member.

6. An image forming apparatus according to claim 5, wherein said positioning member of said image bearing member has an exposing unit positioned thereon, said exposing unit forming a latent image on said image bearing member.

7. An image forming apparatus according to claim 6, wherein said apparatus main body has a fitting section that position said intermediate transfer unit due to fitting with a section-to-be-fitted disposed in said intermediate transfer unit, and said fitting section has an engaging section that engages with said intermediate transfer unit against a pressing force of said secondary transfer unit toward said intermediate transfer member.

8. An image forming apparatus according to claim 7, wherein said secondary transfer unit is swingably disposed on said apparatus main body, and that presses said intermediate transfer belt when said second opening and closing member is closed with said first opening and closing member closed.

9. An image forming apparatus according to claim 8, wherein said intermediate transfer unit is declined toward said secondary transfer unit with said first opening and closing member closed.
